(19) United States
(12) Patent Application Publication
(10) Pub. No.: US 2004/0099657 A1
(43) Pub. Date: May 27, 2004

(54) Method for producing thin film heating element and heating device using same

(76) Inventor: Sung-Don Park, Koyang-si (KR)

Correspondence Address: LOWE HAUPTMAN GILMAN & BERNER, LLP, Suite 300, 1700 Diagonal Road, Alexandria, VA, 22314, US

(21) Appl. No.: 10/715,554

(22) Filed: Nov. 19, 2003

Related U.S. Application Data
(62) Division of application No. 10/031,611, filed on Jan. 22, 2002, now abandoned.
Application No. 10/031,611 is a 371 of international application No. PCT/KR01/00840, filed on May 21, 2001.

(30) Foreign Application Priority Data
May 22, 2000 (KR) 2000-27482

(51) Int. Cl. H05B 3/08; B41M 1/00; B32B 31/00

(52) U.S. Cl. 219/543; 156/281; 219/541

(57) ABSTRACT

A method of producing a thin film heating element is provided which can be used in manufacturing a transparent thin film heating element of desired shape with an increased heat emission property and an excellent durability. Also provided is a heating device of the type incorporating the thin film heating element produced by this method. The inventive method comprises the steps of, applying heat- and oil-resistant ink on a predetermined surface area of a base element, allowing the ink to run dry, spraying conductive chemical composition on the base element to form a conductive thin heater film, removing the ink out of the base element, printing a thin film electrode leading to the thin heater film, and baking the base element into a thin film heating element.

### TECHNICAL FIELD

The present invention relates to a method of producing a thin film heating element whereby the thin film heating element which is transparent and excellent in heat generating property and durability can be easily produced into a desired shape. The invention is also directed to a heating device that makes use of the thin film heating element.

### BACKGROUND ART

In order to form a conductive thin film on a surface of a material, a dipping process, a vacuum deposition process, a sputtering process, a spraying process, and the like are generally used. Since the conductive thin film is usually formed at a temperature of 300° C. or lower according to the dipping method, the vacuum deposition method or the sputtering method, the shape of the coated material is kept unchanged, meaning that the conductive thin film is suitable for producing a transparent electrode of a flat panel display device, for preventing dew condensation and for the manufacture of an anti-static glass. However, since the conductive thin film has insufficient heat resistance, impact resistance, chemical resistance and close adherence between the material and the conductive thin film, it is not suitable for use in a heating element.

Korean Patent Publication No. 97-171971 has proposed a technology of producing a metallic thin film heating element, which comprises the steps of vaporizing a base solution consisting of tin (IV) chloride, fluorine, antimony and distilled water using an inert gas as a carrier; spraying the vaporized base solution on a preheated substrate so as to form a thin film; and removing a remaining portion except a heat generating portion from the thin film formed on the substrate.

According to this technology, there is an advantage in that a heating device can be produced by means of the metallic thin film heating element. However, since the carrier should be used under a low pressure while the base solution is vaporized, the amount of the vaporized base solution capable of reaching the preheated substrate is greatly reduced due to increased heat by the substrate. Thus, there is a problem in that the formation of the thin film is hindered. Further, in a case where compositions of the hydrogen fluoride (HF) during the preparation of the solution is 1 to 10 wt %, all the substrate contains silicon, and tin oxide film should be removed by using an etchant containing hydrogen fluoride. Thus, there is another problem in that the substrate is damaged in its external shape. Furthermore, although the metallic thin film is formed to be 500 to 1000 Å in thickness, its watt density is raised to 4.5 W/cm² if the thickness is 5000 Å or more. Thus, there is a further problem in that the metallic thin film is broken and cannot function as a heating device in a case where an operating voltage or lower is applied to the film.

### DISCLOSURE OF INVENTION

Therefore, the present invention is contemplated to solve the aforementioned problems inherent in the prior art technology. An object of the present invention is to provide a method of producing a thin film heating element which is excellent in a heat generating property and durability, and a heating device using the thin film heating element.

Another object of the present invention is to provide a method of producing a thin film heating element which is transparent, and a heating device using the thin film heating element.

A further object of the present invention is to provide a method of producing a heating element capable of forming the heating element into a desired shape with ease, and a heating device using the thin film heating element.

According to an aspect of the present invention, there is provided a method of producing a thin film heating element, comprising the steps of: masking an surface except a heat generating portion of a material with heat- and oil-resistant ink and then drying the material; preheating the material and spraying a conductive composition for the thin film heating element on a surface of the preheated material using clean air as a carrier so as to form a conductive thin film for the thin film heating element; removing the ink from the material by water cleaning; printing the conductive thin film for the thin film heating element with a conductive thin film for an electrode and then drying the conductive thin film; and baking the material.

According to another aspect of the present invention, there is also provided a heating device using a thin film heating element, comprising: a pair of frames opposed to each other; a plurality of flat substrates parallel mounted at one side of the frames by predetermined intervals; a heat generating portion consisting of the thin film heating element formed on the surface of each of the substrate by the method as claimed in claim 1; and a blowing means installed at the other side of the frames for blowing air to the heat generating portion.

### BRIEF DESCRIPTION OF THE DRAWINGS

FIG. 1 is a perspective view showing a first embodiment of a heating device using a thin film heating element according to the present invention.

FIG. 2 is a front view of the heating device shown in FIG. 1 with it being partially cut away.

FIG. 3 is a perspective view showing a second embodiment of the heating device using the thin film heating element according to the present invention.

FIG. 4 is a sectional view of the heating device shown in FIG. 3.

FIG. 5 is a perspective view showing a third embodiment of the heating device using the thin film heating element according to the present invention.

FIG. 6 is a sectional view of the heating device shown in FIG. 5.

### BEST MODE FOR CARRYING OUT THE INVENTION

Preferred embodiments of a method of producing a thin film heating element and a heating device using the thin film heating element according to the present invention will now be explained in detail.

First, according to the method of producing the thin film heating element of the present invention, a conductive composition for the thin film heating element includes tin as a major ingredient and other elements as additives. Preferably, the thin film heating element composition consists of tin (IV) chloride, antimony chloride, hydrochloric acid, indium chloride, and distilled water. Specifically, the composition consists of 15 to 20 wt % of tin (IV) chloride, 1 to 1.5 wt % of antimony chloride, 10 to 15 wt % of hydrochloric acid, 1 to 1.5 wt % of indium chloride and 55 to 60 wt % of distilled water. The composition is mixed by a shaker for approximately 72 hours.

It is particularly advantageous to employ a transparent glass or ceramic having an increased thermal resistance and a low thermal expansion property, as a base material on which a heat generating portion is formed. The ceramic comprises semicrystalline ceramic including one or more crystalline phases. Aluminum oxide, petalite, mullite, cordierite, ceramic products Nos. N-0, N-11, GC190 produced by NEG (Nippon Electric Glass Co., Ltd.) and a quartz plate or tube can be used. Preferably, these materials should have a thermal expansion coefficient less than 3×10⁻⁶/° C. within a temperature range of 0 to 300° C. so as to reduce thermal stress.

The surface of the material except the heat generating portion is masked with heat- and oil-resistant ink which is then allowed to run dry. In addition, the material is preheated up to a temperature of 500 to 800° C. and the conductive composition for the heating element is sprayed on the surface of the preheated material so as to form a thin film. In the process of spraying the conductive composition for the heating element, clean air from which impurities including water and oil have been removed is used as a carrier. In a case where the spraying is performed on the same material under the same spaying conditions, a thin film which has a low electric resistance and excellent visible light transmissivity at a high temperature can be obtained.

Next, the ink which has been masked on the surface of the material is removed by water cleaning, and the conductive composition for the thin film heating element is printed with a conductive thin film for an electrode and then dried. The conductive thin film for the electrode is preferably formed of silver. The material printed with the conductive thin film for the electrode is baked at a high temperature of approximately 600° C. As a result, the thin film heating element can be produced whereby heat is generated from the conductive thin film composition for the heating element as electric voltage is applied thereto.

If tin (IV) chloride is added to the conductive composition of the present invention as high an amount as 40 wt %, hydrolysis will not be carried out in a proper manner and haze will be left on the conductive thin film which leads to a reduced film transparency. Furthermore, the conductive thin film will become highly unstable, thus resulting in a localized heat generation. In addition, the conductive thin film may be broken when exposed to the heat of approximately 300° C. This means that the conductive thin film containing too large amount of tin (IV) chloride is not good for use in the heating device. Accordingly, it is preferred that tin (IV) chloride should be no more than about 20 wt %.

In the meantime, antimony chloride content in excess of about 1.5 wt % will result in insufficient hydrolysis, reduced film transparency and increased susceptability to damage of the resultant film. Moreover, if hydrochloric acid is not contained at all, hydrolysis will hardly occur and there will be difficulty in storing the conductive composition for a prolonged period of time.

Experimental results as to whether the antimony chloride has influence on the thickness of the conductive thin film are shown in Table 1. Material used in Examples 1 to 5 is Ceramic Product No. N-0 having a thickness of 0.3 mm and a size of 150 mm², which has been manufactured and sold by NEG. The time period for spraying the conductive composition for the thin film heating element is 1.5 second, and the feeding speed of the material is 1 m/min.

TABLE 1
Influence of antimony chloride content on the thickness of
conductive thin film(unit:Å)

| | Material | Antimony Chloride | | | | |
|---|---|---|---|---|---|---|
| | Temperature | (wt %) | | | | |
| | (° C.) | 0.3 | 0.5 | 1.0 | 1.2 | 1.5 |
| Example 1 | 750 | 2000 | 2800 | 3400 | 3800 | 4200 |
| Example 2 | 700 | 1400 | 1900 | 2600 | 3200 | 3800 |
| Example 3 | 650 | 1000 | 1400 | 2400 | 2400 | 2900 |
| Example 4 | 750 | 2400 | 3200 | 3800 | 4100 | 4700 |
| Example 5 | 750 | 2400 | 3200 | 3600 | 4200 | 4820 |

As can be seen from Example 1 in Table 1, the conductive thin film for the heating element becomes thicker in proportion to the content of antimony chloride, but its light transmissivity becomes reduced in inverse proportion to the antimony chloride content. Therefore, the antimony chloride content may be properly controlled depending on the requirements such as heat generating temperature, light transmissivity and the kinds of the material. According to the Examples 2 and 3, it can be seen that when the material temperature is lowered from 750° C. to 700° C. and 650° C., respectively, under the same conditions as in Example 1, the conductive thin film for the heating element becomes thinner.

In Example 4, the period of time for spraying the conductive composition for the thin film heating element was changed to 2 seconds with other conditions remaining the same as in Example 1. It can be appreciated that the more the antimony content, the thicker the conductive thin film. In Example 5, the feeding speed of the material was changed to 1.5 m/min with other conditions kept the same as in Example 1. It can be seen that the more the antimony content, the thicker the conductive thin film.

In addition, the influence of indium chloride content on the thickness of the conductive thin film are shown in Table 2 wherein indium chloride is added in place of antimony chloride under the same conditions as in Example 1.

TABLE 2
Influence of indium chloride on the thickness of conductive
thin film(unit:Å)

| | Material | Indium Chloride | | | | |
|---|---|---|---|---|---|---|
| | Temperature | (wt %) | | | | |
| | (° C.) | 0.1 | 0.3 | 0.5 | 0.7 | 1.0 |
| Example 6 | 750 | 2800 | 3200 | 3600 | 4000 | 4800 |

As can be seen from Table 2, as an indium chloride content is increased, the conductive thin film for the heating element becomes thicker with attendant increase of its light transmissivity.

In the mean time, when producing the thin film heating element according to the present invention, it is important to precisely adjust the thickness of the conductive thin film. Preferably, the thickness of the conductive thin film for the heating element is 500 to 5000 Å, and the conductive thin film for the heating element having such thickness can be formed by a single process. In a case where the thickness of the conductive thin film is less than 500 Å, the amount of heat generation becomes too small. On the other hand, in a case where the thickness of the conductive thin film exceeds 5000 Å, the amount of heat generation becomes too large. Thus, the thin film heating elements produced under both cases are not good for use in the intended heating device. The heating device should be produced by way of taking into account the material temperature, the period of time for spraying the conductive composition, the feeding speed of the material, the reactivity between the material and the conductive composition for the heating element, the heat temperature, the heating area and the applied voltage.

Inasmuch as the thin film heating element of the present invention is adapted to generate high-temperature heat from a broad surface thereof, it can be used as an industrial or household heater for the sake of heating and drying various kinds of industrial products, and also as a heating device for removing frost and water droplets from a car window. In addition, the inventive thin film heating element can be utilized as a cooker. In such a case, it is preferred that the amount of heat generation be controlled to fall within the range of 100 to 750° C. In order to assure such amount of heat generation, the electric resistance of the conductive thin film is preferably set to 10 to 1000Ω/square.

A number of embodiments of a heating device incorporating the thin film heating element according to the present invention will now be set forth with reference to the accompanying drawings.

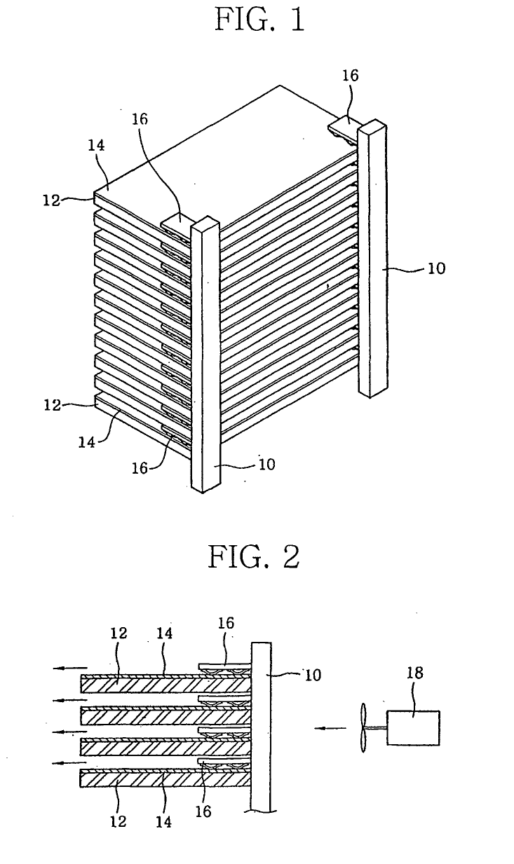

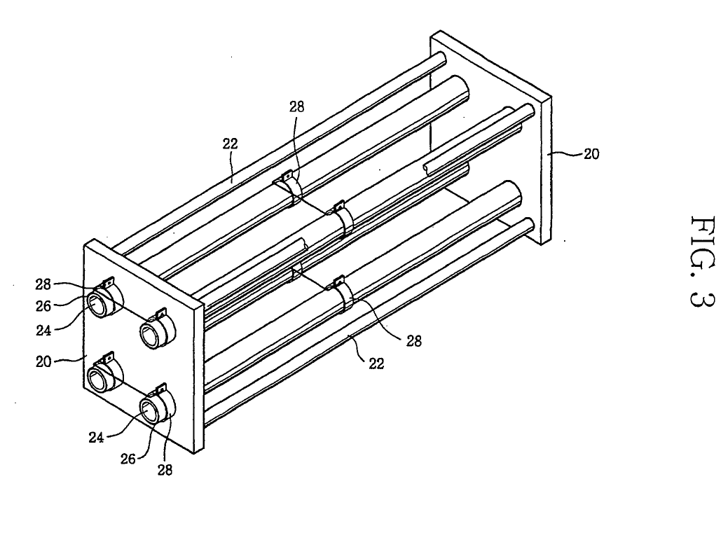

FIGS. 1 and 2 show a first embodiment of the heating device according to the present invention. The heating device according to the first embodiment of the present invention comprises a pair of frames 10 which are opposed to each other and spaced apart at a predetermined interval. A plurality of heat resistant flat substrates 12 are horizontally mounted at one side of each of the frames to be spaced apart from each other at predetermined intervals. A heat generating portion 14 formed by the method of producing the thin film heating element as described above is provided on a surface of each of the substrate 12, and a pair of electrodes 16 for applying voltage are attached to two corners of the heat generating portion 14. The supply of electric power via the electrodes 16 is performed by a power supply (not shown) which controls current intensity to adjust heat generating temperature of the heat generating portion 14. A blower 18 is further installed at the opposite side of the frames 10 to the substrates. Air blown by the blower 18 passes between the substrates 12 and is heated into hot air by the heat generated from the heat generating portion 14. Therefore, the heating device of the first embodiment of the present invention is good for use in a hot air blower or a drier.

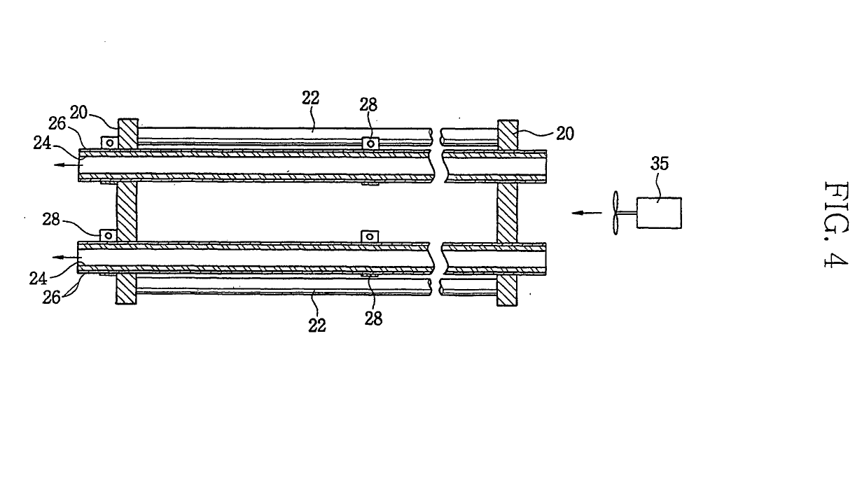

Referring next to FIGS. 3 and 4 in which a heating device of a second embodiment of the present invention is shown, the heating device comprises a pair of opposite frames 20 which are spaced apart at a predetermined interval. The frames 20 are fixedly connected to each other by fixing rods 22, and a plurality of heat resistant tubes 24 with open opposite ends pass through and are horizontally mounted between the frames 20. A heat generating portion 26 formed by the method of producing the thin film heating element according to the present invention is provided on an outer surface of the tubes 24, and a pair of electrodes 28 for applying voltage are attached to the heat generating portion 26 at predetermined intervals. The supply of electric power via the electrodes 28 is performed by a power supply (not shown) which controls current intensity to adjust heat generating temperature of the heat generating portion 26. A blower 30 is further installed at one side of one of the frames 20. Air blown by the blower 30 passes through the tubes 24, and is heated into hot air by the heat generated from the heat generating portion 26. Therefore, the heating device of the second embodiment is good for use in a hot air blower or a drier. Alternatively, the heat generating portion 26 may be mounted on an inner surface of each of the tubes 24, and the electrodes 28 may also be mounted on an inner surface of each of the tubes 24.

The heat generating portions 14, 26 of the heating devices of the first and second embodiment produced by the thin film heating element according to the present invention can generate heat of high temperature and have a excellent durability. Further, the heat generating portions can be easily formed into a desired shape and have very high thermal efficiency as compared with their power consumption. Although the substrates 12 and tubes 24 on which the heat generating portions 14, 24 are respectively formed are of flat or cylindrical shape in the illustrated embodiments, they may be formed into a circular, elliptical or other desired shape.

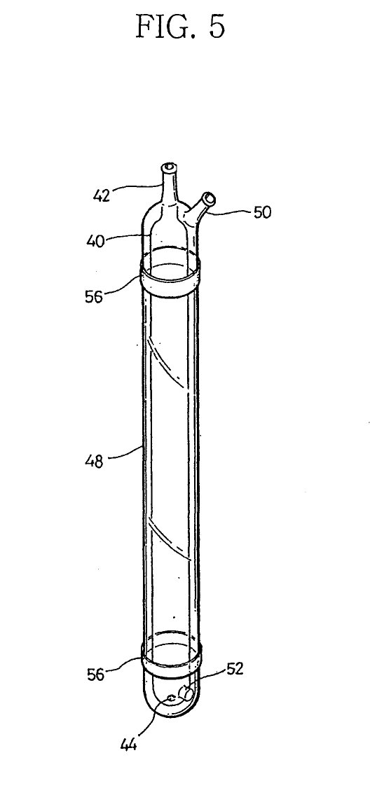

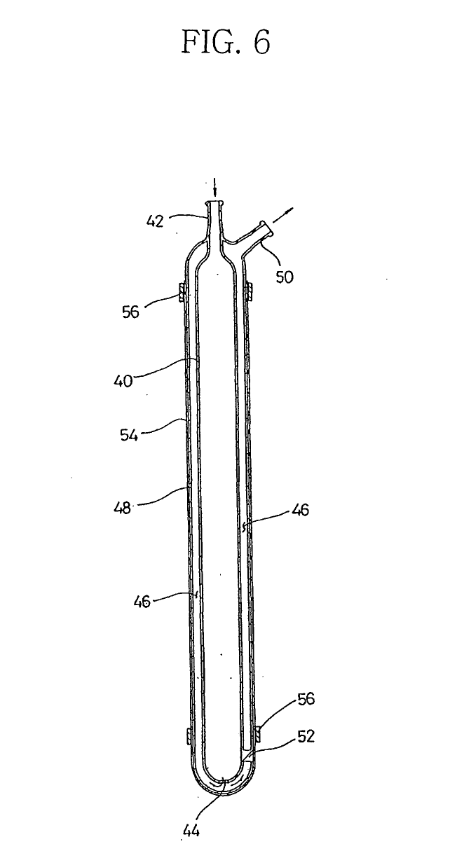

Referring finally to FIGS. 5 and 6, there is illustrated a heating device according to a third embodiment of the present invention.

The heating device shown in FIGS. 5 and 6 comprises an inner container 40 which includes an upper inlet port 42 of a. slender tubular shape, through which liquid such as water can be easily introduced, and a lower drain port 44. An outer container 48 surrounding the inner container 40 is provided at an outer side of the inner container 40 so as to form a channel 46 through which the liquid discharged from the drain port 44 can flow, and an upper end of the outer container 48 is integrally formed with that of the inner container 40. An upper portion of the outer container 48 is formed with a drain port 50 which remains in communication with the channel 46. A connecting portion 52 which integrally connects the inner container 40 and the outer container 48 to reinforce their strength is formed at a lower portion of a space between the two containers.

In addition, the outer container 48 is provided on its outer surface with a heat generating portion 54 formed by the method of producing the thin film heating element according to the present invention, and a pair of electrodes 56 for applying voltage are attached to the heat generating portion 54 at predetermined intervals. The supply of electric power via the electrodes 56 is performed by a power supply (not shown) which controls current intensity to adjust heat generating temperature of the heat generating portion 54.

In operation of the heating device of the third embodiment as constructed above, water, for example, is introduced through the inlet port 42 into the inner container 40 and is discharged through the drain port 44 of the inner container 40. Thereafter, the water flows along the channel 46 between the inner container 40 and the outer container 48. At this time, when voltage is applied to the electrodes 56, the heat generating portion 54 will generate heat, and the water flowing in the inner container 40 and along the channel 46 is heated into hot water. The hot water in the channel 46 is discharged through the drain port 50 to the outside. Since the water sequentially flowing in the inner container 40 and along the channel 46 is heated two times by the heat generated from the heat generating portion 54, there is an advantage in that the heating device has high thermal efficiency as compared with its power consumption and the water can be quickly heated. Therefore, the heating device of the third embodiment of the present invention is highly suitable for use as an instantaneous water heater.

The above embodiments are only for the purpose of describing desirable embodiments of the present invention, the present invention is not limited to the above embodiments and may be appropriately modified within the spirit and scope of the present invention. For example, various modifications to the shapes and structures of components shown in the above embodiments of the present invention may be made, and it will be appreciated to the skilled person in the art that the present invention is intended to include changes, modifications or substitutions to the present invention.

### Industrial Applicability

As described above, according to a method of producing a thin film heating element and a heating device using the thin film heating element, the transparent thin film heating element having an excellent heat generating property and durability can be easily produced and can be formed into a desired shape.

1. A method of producing a thin film heating element, comprising the steps of:
masking a surface of a material except a heat generating portion with heat- and oil-resistant ink and allowing the ink to run dry;
preheating the material and spraying a conductive composition for the thin film heating element on a surface of the preheated material using clean air as a carrier to form a conductive thin film for the thin film heating element;
removing the ink from the material by water cleaning;
printing the conductive thin film for the thin film heating element with a conductive thin film for an electrode and then drying the conductive thin film for the electrode; and
baking the material.

2. The method as claimed in claim 1, wherein the conductive composition for the thin film heating element consists of 15 to 20 wt % of tin (IV) chloride, 1 to 1.5 wt % of antimony chloride, 10 to 15 wt % of hydrochloric acid, 1 to 1.5 wt % of indium chloride and 55 to 60 wt % of distilled water.

3. The method as claimed in claim 1, wherein the material is transparent glass or ceramic having thermal resistance and a low thermal expansion property.

4. The method as claimed in claim 1 or 3, wherein the material is preheated to a temperature of 500 to 800° C.

5. The method as claimed in claim 1 or 3, wherein the material has a thermal expansion coefficient less than 3×10⁻⁶/° C. at a temperature of 0 to 300° C.

6. The method as claimed in claim 1, wherein the conductive thin film for the heating element has an electric resistance of 10 to 1000Ω/square.

7. The method as claimed in claim 1 or 6, wherein the conductive thin film for the heating element has a thickness of 500 to 5000 Å.

8. The method as claimed in claim 1, wherein the conductive thin film for the electrode comprises silver.

9. A heating device using a thin film heating element, comprising:
a pair of frames opposed to each other;
a plurality of flat substrates which are horizontally mounted at one side of each of the frames and spaced apart from each other at predetermined intervals;
a heat generating portion consisting of the thin film heating element formed on a surface of each of the substrate according to the method of claim 1; and
a blowing means installed at the other side of each of the frames for blowing air to the heat generating portion.

10. A heating device using a thin film heating element, comprising:
a pair of frames opposed to each other;
a plurality of tubes which pass through and are mounted to the frames;
a heat generating portion consisting of the thin film heating element formed on each of the tubes according to the method of claim 1; and
a blowing means installed at an outer side of any one of the frames for blowing air to the heat generating portion.

11. A heating device using a thin film heating element, comprising:
an inner container having an upper inlet port through which liquid can be introduced and a lower drain port for discharging the liquid;
an outer container surrounding the inner container with a predetermined gap formed therebetween so as to define a channel through which the liquid discharged from the drain port of the inner container can flow, an upper end thereof being integrally formed with that of the inner container, an upper portion thereof being formed with a drain port through which the liquid flowing along the channel can be discharged; and
a heat generating portion including the thin film heating element formed on an outer surface of the outer container according to the method of claim 1.
